(19) United States
(12) Patent Application Publication
(10) Pub. No.: US 2017/0308253 A1
(43) Pub. Date: Oct. 26, 2017

(54) DRIVE MODE FEATURE DISCOVERY

(71) Applicant: Motorola Mobility LLC, Chicago, IL (US)

(72) Inventors: Amit Kumar Agrawal, Bangalore (IN); Satyabrata Rout, Bangalore (IN)

(21) Appl. No.: 15/137,557

(22) Filed: Apr. 25, 2016

(51) Int. Cl. G06F 3/0484; G06F 1/16; G06F 3/16; G06F 9/44

(52) U.S. Cl. CPC G06F 3/0484; G06F 9/4446; G06F 1/1694; G06F 3/167

(57) ABSTRACT

A method includes determining that a device is in a driving state and prompting a user to enable a hands-free mode of operation responsive to detecting a manual interaction with the device by the user while the device is in the driving state. A device includes a display, at least one sensor to detect motion of the device, and a processor to detect a driving state of the device based on the motion and prompt a user of the device to enable a hands-free mode of operation responsive to detecting a manual interaction with the device by the user while the device is in the driving state.

### BACKGROUND

### Field of the Disclosure

The disclosed subject matter relates generally to mobile computing systems and, more particularly, to assist a user with activating drive mode functionality in a mobile device.

### Description of the Related Art

Many mobile devices allow user interaction through natural language voice commands to implement a hands-free mode of operation. Typically, a user presses a button or speaks a “trigger” phrase to enable the hands-free mode. In one example, a user may desire to operate in a hands-free mode and use voice commands while driving. Some mobile devices automatically detect a driving state and implement a hands-free mode that relies on voice communication with and from the user. Incoming messages or the identity of an incoming caller may be read to the user. The user may reply to the message or answer the call using voice responses. Assist features, such as drive mode, require the user to enable and set up the parameters of the feature. However, it is often the case that a user is not aware of all of the capabilities of the mobile device, for example, after purchasing a new device or upgrading an operating system. If the feature is not enabled, the user may not realize the value of or take advantage of the feature.

The present disclosure is directed to various methods and devices that may solve or at least reduce some of the problems identified above.

### BRIEF DESCRIPTION OF THE DRAWINGS

The present disclosure may be better understood, and its numerous features and advantages made apparent to those skilled in the art by referencing the accompanying drawings.

FIG. 1 is a simplified block diagram of a communication device configured to assist a user with drive mode feature discovery, in accordance with some embodiments;

FIG. 2 is a flow diagram of a method for assisting a user with drive mode feature discovery, in accordance with some embodiments; and

FIG. 3 is a diagram of a user interface for prompting the user to configure the hands-free drive mode, in accordance with some embodiments.

The use of the same reference symbols in different drawings indicates similar or identical items.

### DETAILED DESCRIPTION OF EMBODIMENT(S)

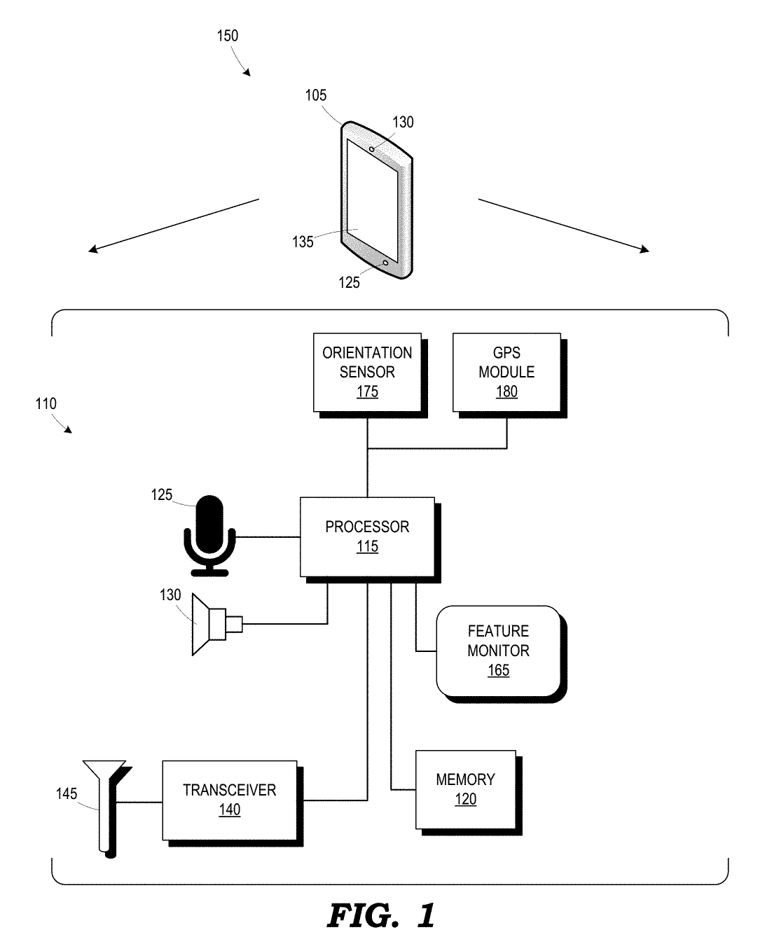

FIGS. 1-3 illustrate example techniques for assisting a user with drive mode feature discovery. In one example, a mobile device may detect that the user is manually interacting with the device while in a driving state. The user may be notified of the drive mode feature based on the interaction detection. The notification of the user allows the user to recognize the value of the drive mode feature and prompt them to configure the feature.

FIG. 1 is a simplistic block diagram of a device 105. The device 105 implements a computing system 110 including, among other things, a processor 115, a memory 120, a microphone 125, a speaker 130, and a display 135. The memory 120 may be a volatile memory (e.g., DRAM, SRAM) or a non-volatile memory (e.g., ROM, flash memory, etc.), or a combination thereof. The device 105 includes a transceiver 140 for transmitting and receiving signals via an antenna 145. The transceiver 140 may include one or more radios for communicating according to different radio access technologies, such as cellular, Wi-Fi, Bluetooth®, ZigBee, etc. In various embodiments, the device 105 may be embodied in handheld or wearable devices, such as a laptop computers, handheld computers, tablet computers, mobile devices, telephones, personal data assistants, music players, game devices, wearable computing devices, and the like.

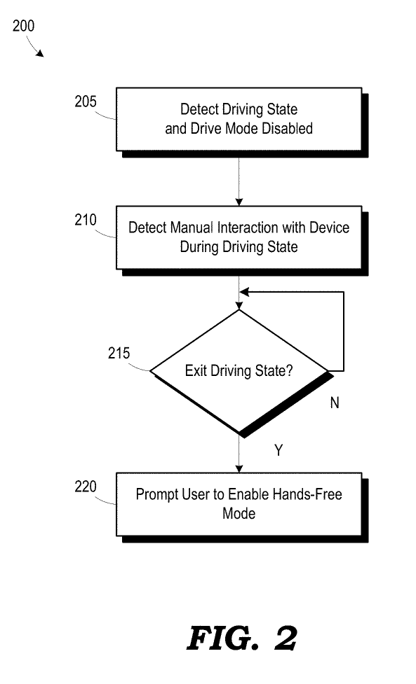

In the device 105, the processor 115 may execute instructions stored in the memory 120 and store information in the memory 120, such as the results of the executed instructions. Some embodiments of the processor 115, the memory 120, and the microphone 125 may be configured to implement a feature monitor 165 that performs portions of a method 200 shown in FIG. 2 and discussed below. The device 105 may be equipped with one or more sensors for use by the feature monitor 165, such as, for example, an orientation sensor 175 (e.g., an accelerometer, magnetometer, mercury switch, gyroscope, compass, or some combination thereof) for measuring the position and/or movement of the device 105 relative to a physical reference point or surface and a global positioning system (GPS) module 180 for detecting a location of the device 105. The sensors 175, 180 may be employed by the feature monitor 165 to identify a driving state.

For example, the processor 115 may execute the feature monitor 165 to detect a driving state and also detect the user manually interacting with the device 105 without a drive mode feature of the device 105 being enabled. The feature monitor 165 may alert the user to the availability of the drive mode feature to improve the user experience when operating the device 105. In some embodiments, the feature monitor 165 may automatically display a message on the display 135 and provide an alert tone on the speaker 130 to inform the user of the drive mode feature availability. In some embodiments, the feature monitor 165 may defer notifying the user until the device 105 is no longer determined to be in a driving state.

FIG. 2 is a flow diagram of a method 200 for assisting a user with drive mode feature discovery, in accordance with some embodiments. In method block 205, the feature monitor 165 detects that the device 105 is in a driving state and that the drive mode feature of the device 105 is disabled. Various techniques may be employed to detect the driving state. In some embodiments, the feature monitor 165 observes vibration patterns using the orientation sensor 175 and matches the patterns to learned features from vehicle training data. After accumulation thresholds for vibration patterns have been met, a secondary velocity estimate (e.g. >˜12 mph) may be employed using the GPS module 180 or based on a network location change to verify the driving state. Although the driving state detection is described herein as being implemented by the feature monitor 165, in some embodiments, a different monitor in the device 105 may determine the driving state and set a flag when the driving state conditions are met. The feature monitor 165 may simply monitor the flag to detect the driving state.

In method block 210, the feature monitor 165 detects a manual interaction with the device 105 while the driving state is active. For example, the user may interface with the display 135 to interact with a calling interface to answer or place a call or with a messaging interface to view or compose an email or text message. In some embodiments, the feature monitor 165 may also determine that the interaction was not successful (e.g., call not answered, no call placed, or no message sent) as a precondition for notifying the user as described below.

In method block 215, the feature monitor 165 determines if the device 105 is still in a driving state. If the driving state is active in method block 215, the feature monitor 165 defers user notification and returns to method block 215. An exit from the driving state may be determined by an accumulation of non-vehicle states (e.g., based on vibration and velocity). In one embodiment, an exit may be identified if a walking state is detected based on the vibration activity.

When the device 105 exits the driving state in method block 215, the feature monitor 165 prompts the user in method block 220 to enable a hands-free mode of operation, such as drive mode. In one embodiment, the feature monitor 165 may display a message on the display 135 of the device 105. The message may also include a user interface for configuring the hands-free mode.

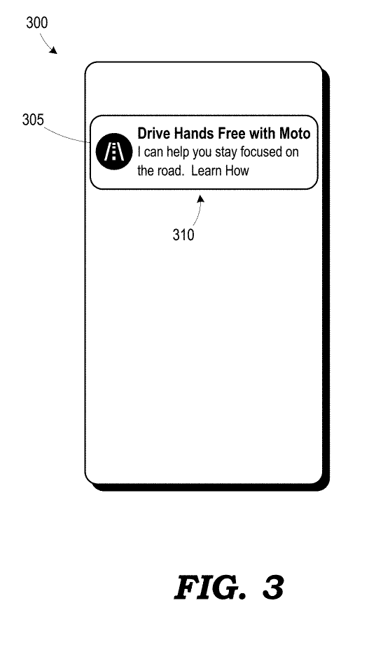

FIG. 3 is a diagram of a user interface 300 for prompting the user to configure the hands-free mode drive mode, in accordance with some embodiments. The user interface 300 includes a message box 305 including a message 310 informing the user of the drive mode capabilities of the device 105. The user may tap on the message box 305 to invoke a configuration interface for enabling the drive mode and setting the drive mode parameters.

In some embodiments, certain aspects of the techniques described above may implemented by one or more processors of a processing system executing software. The method 200 described herein may be implemented by executing software on a computing device, such as the processor 115 of FIG. 1, however, such methods are not abstract in that they improve the operation of the device 105 and the user's experience when operating the device 105. Prior to execution, the software instructions may be transferred from a non-transitory computer readable storage medium to a memory, such as the memory 120 of FIG. 1.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

A method includes determining that a device is in a driving state and prompting a user to enable a hands-free mode of operation responsive to detecting a manual interaction with the device by the user while the device is in the driving state.

A device includes a display, at least one sensor to detect motion of the device, and a processor to detect a driving state of the device based on the motion and prompt a user of the device to enable a hands-free mode of operation responsive to detecting a manual interaction with the device by the user while the device is in the driving state.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

What is claimed is:

1. A method, comprising:
determining that a device is in a driving state; and
prompting a user to enable a hands-free mode of operation responsive to detecting a manual interaction with the device by the user while the device is in the driving state.

2. The method of claim 1, further comprising detecting a failure of the manual interaction, and prompting the user comprises prompting the user responsive to detecting the failure.

3. The method of claim 1, wherein detecting the manual interaction comprises detecting an interaction with a calling interface on the device.

4. The method of claim 3, further comprising detecting a failure of the interaction with the calling interface, and prompting the user comprises prompting the user responsive to detecting the failure.

5. The method of claim 1, wherein detecting the manual interaction comprises detecting an interaction with a messaging interface on the device.

6. The method of claim 5, further comprising detecting a failure of the interaction with the messaging interface, and prompting the user comprises prompting the user responsive to detecting the failure.

7. The method of claim 1, further comprising deferring the prompting of the user until determining that the device has exited the driving state subsequent to detecting the manual interaction.

8. The method of claim 1, wherein prompting the user comprises providing a message on a display of the device.

9. The method of claim 1, wherein prompting the user comprises providing a user interface for configuring the hands-free mode on a display of the device.

10. The method of claim 1, wherein the hands-free mode of operation comprises a voice-driven mode of interaction.

11. A device, comprising:
a display;
at least one sensor to detect motion of the device; and
a processor to detect a driving state of the device based on the motion and prompt a user of the device to enable a hands-free mode of operation responsive to detecting a manual interaction with the device by the user while the device is in the driving state.

12. The device of claim 11, wherein the processor is to detect a failure of the manual interaction and prompt the user responsive to detecting the failure.

13. The device of claim 12, wherein the processor is to detect the manual interaction by detecting an interaction with a calling interface on the device.

14. The device of claim 13, wherein the processor is to detect a failure of the interaction with the calling interface and prompt the user responsive to detecting the failure.

15. The device of claim 11, wherein the processor is to detect the manual interaction by detecting an interaction with a messaging interface on the device.

16. The device of claim 15, wherein the processor is to detect a failure of the interaction with the messaging interface and prompt the user responsive to detecting the failure.

17. The device of claim 11, wherein the processor is to defer the prompting of the user until determining that the device has exited the driving mode based on the motion subsequent to detecting the manual interaction.

18. The device of claim 11, wherein the processor is to prompt the user by providing a message on a display of the device.

19. The device of claim 11, wherein the processor is to prompt the user by providing a user interface for configuring the hands-free mode on a display of the device.

20. The device of claim 11, wherein the hands-free mode of operation comprises a voice-driven mode of interaction.
